(19) United States
(12) Patent Application Publication
(10) Pub. No.: US 2026/0173234 A1
(43) Pub. Date: Jun. 18, 2026

(54) METHOD AND ILLUMINATION UNIT FOR ILLUMINATING A DETECTION AREA OF A CODE READER

(71) Applicant: VITRONIC Machine Vision GmbH, Wiesbaden (DE)

(72) Inventors: Marco SEILLER, Geisenheim (DE); Burghard HOFFMANN, Taunusstein (DE)

(73) Assignee: VITRONIC Machine Vision GmbH, Wiesbaden (DE)

(21) Appl. No.: 19/417,952

(22) Filed: Dec. 12, 2025

(30) Foreign Application Priority Data
Dec. 13, 2024 (EP) 24220003.8

(51) Int. Cl. H05B 45/59; H05B 45/10

(52) U.S. Cl. CPC H05B 45/59; H05B 45/10

(57) ABSTRACT

A method for illuminating a detection area of an imaging sensor by means of an illumination unit with at least one light source is provided. The light intensity of the light emitted by the at least one light source is varied between light pulse intervals, light base illumination intervals, and light pause intervals. A light pause interval is located immediately before and immediately after a light pulse interval, respectively. A light base illumination interval, which has a light intensity less than that of the light pulse intervals, is provided between each of the light pause intervals that are provided between two light pulse intervals.

### CROSS-REFERENCE TO RELATED APPLICATIONS

This application claims priority to and the benefit of EP 24220003.8

filed on Dec. 13, 2024. The disclosure of the above application is incorporated herein by reference.

### FIELD

The present disclosure relates to a method for illuminating a detection area of an imaging sensor by means of an illumination unit with at least one light source, and an illumination unit for illuminating a detection area of an imaging sensor comprising at least one light source.

### BACKGROUND

The statements in this section merely provide background information related to the present disclosure and may not constitute prior art.

Well-lit image and video recordings from cameras with imaging sensors require lighting that emits very bright light. In a method and an illumination unit for illuminating a detection area of an imaging sensor, objects bearing a code are guided past a code reader, whereby the code is detected by means of an imaging sensor and decoded by a computing unit. Strong lighting is necessary for precise code illumination and recognition, as ambient light is usually not sufficient. The code readers are therefore equipped with particularly bright lighting.

To avoid motion blur when reading codes on moving objects, the lighting is operated in short pulses. This method also saves energy and reduces heat generation. However, pulsed lighting can be perceived as flickering, which can be disturbing or even harmful to people in the vicinity.

To prevent the light from a pulsed illumination unit from being perceived as flickering, the illumination unit can be operated with a high pulse frequency greater than 100 Hz. Above this pulse frequency, the human eye no longer perceives light pulses and the lighting appears as continuous light. However, this leads to a high load on the light sources, such as LEDs, of the illumination unit, which drastically reduces the service life of the light sources (LEDs).

DE 10 2019 128 710 A1 shows a method and an illumination unit of the type mentioned at the beginning.

DE 10 2010 050 577 B4 describes a flicker-reduced LED illumination device that is operated in a pulsed mode with light pulses and pulse pauses, whereby a lighting intensity other than zero is maintained in the pulse pauses so that a basic brightness always remains. The basic brightness is so high that the difference to the light pulses is not perceived as disturbing by the human eye. This means that a basic brightness remains during the pulse pauses and the lighting intensity is not reduced to zero, but remains permanently above a predetermined value, so that flickering is reduced but not eliminated during exposure.

A similar illumination device is described in U.S. Pat. No. 7,433,590 B2. Here, pulsed LED lighting with a frequency of at least 60 Hz is synchronized with the electronic shutter of a camera. Here too, the lighting intensity remains permanently above zero during the pulse pauses and serves to reduce flickering.

DE 103 49 553 B4 describes a method for brightness control and dynamic color mixing of LEDs, the brightness of which can be uniformly controlled in a planar illumination, whereby the brightness control of different brightness levels is uniform and, in particular, not visible to the human eye in the transition from 0% to the lowest brightness level. The brightness is controlled via pulse modulation in conjunction with variable current regulation of the driver current.

WO 2013/141876 A2 shows an illumination system of a code reader which generates an illumination comprising an essentially continuous illumination period and at least one pulsed illumination period. In the essentially continuous illumination period, the light emitted by the illumination system has a lower light intensity than in the pulsed illumination period. In order to optimally image and decode codes from different sources, such as on a printout, on an LCD display or on moving objects, the shutter duration (exposure time) of the imaging sensor can be adjusted. At the end of the shutter duration of the imaging sensor, the image data is read out, whereby the continuous illumination period can be terminated after readout so that the light intensity drops to zero. During the shutter duration, pulsed lighting with high light intensity takes place, which is immediately followed by a continuous lighting period with lower light intensity. To keep the shutter duration as short as possible, lighting is always present during the shutter duration.

### SUMMARY

This section provides a general summary of the disclosure and is not a comprehensive disclosure of its full scope or all of its features.

An aspect of the present disclosure is to operate an illumination unit for illuminating a detection area of an imaging sensor for the human eye with as little flicker as possible.

According to this aspect, a method for illuminating a detection area of an imaging sensor by means of an illumination unit with at least one light source is proposed. The light intensity of the light emitted by the at least one light source is varied between light pulse intervals, light base illumination intervals and light pause intervals. The frequency of the successive light pulse intervals is less than 60 Hz. A light pause interval is located immediately before and immediately after a light pulse interval, respectively. A light base illumination interval, the light intensity of which is less than the light intensity of the light pulse intervals, is provided between each of the light pause intervals that are located between two light pulse intervals.

The light intensity of the light base illumination interval corresponds to the average value of the light intensity of a cycle, i.e. from the start of a light pulse interval to the start of the following light pulse interval. This means that the light pulse intervals are not perceived as flickering. Alternatively or additionally, the light intensity of a light pulse interval and the light pause intervals that are arranged immediately before and after the light pulse interval corresponds to the average value of the light intensity from the start of a light pulse interval to the start of the following light pulse interval.

The light intensity during a light pulse interval can decrease, in particular by a maximum of up to 10% or a maximum of up to 20% of the highest light intensity.

The frequency of the successive light pulse intervals can be less than 30 Hz.

The duration of a light pulse interval can be 500 μs or less.

The light pause intervals that are arranged immediately before and immediately after a light pulse interval can be at least essentially equal in length.

The duration of a light pulse interval can be 5 ms or less.

The at least one light source can be controlled by means of a driver control, wherein the driver control generates a drive current signal to control the at least one light source, which can be an LED, an OLED or a laser, for example.

The at least one light source can be an LED or an LED string comprising a plurality of LEDs, which is controlled in the light pulse interval with a drive current with a current intensity of 8 A. With an LED or LED string as the light source, the current intensity of the driver current for the light base illumination interval can be between 150 mA and 450 mA.

The illumination unit can comprise at least one first light source and at least one second light source, the at least one first light source being actuated to generate the light of the light pulse interval and the at least one second light source being actuated to generate the light of the light base illumination interval.

The object is further achieved by an illumination unit for illuminating a detection area of an imaging sensor. The illumination unit comprises at least one light source, and a driver control for driving the at least one light source by means of a drive current signal. The driver control is configured to vary the drive current signal between light pulse intervals, light base illumination intervals and light pause intervals. The frequency of the successive light pulse intervals is less than 60 Hz. The driver control is designed in such a way that the drive current signal has a light pause interval immediately before and immediately after a light pulse interval, respectively, and that a light base illumination interval, in which the current intensity of the driver current signal is lower than the current intensity of the driver current signal in the light pulse intervals, is located between the light pause intervals that are located between two light pulse intervals. The driver control controls the drive current signal in such a way that the light intensity of the light base illumination interval corresponds to the average value of the light intensity of a cycle and/or the light intensity of a light pulse interval and the light pause intervals that are located immediately before and after the light pulse interval corresponds to the mean value of the light intensity of a cycle.

The at least one light source can be an LED.

For all specified values and parameters, a deviation (tolerance) of up to 5% of the specified value is still considered to be covered by the aspects of this disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings. The illumination unit in various applications is explained in more detail below using the drawings, in which:

FIG. 1 is a schematic diagram of the light intensity of the light from the illumination unit over time;

FIG. 2 is a schematic representation of the use of an illumination unit in a traffic monitoring system; and

FIG. 3 is a schematic representation of the use of an illumination unit in a code reading system of a parcel sorting system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

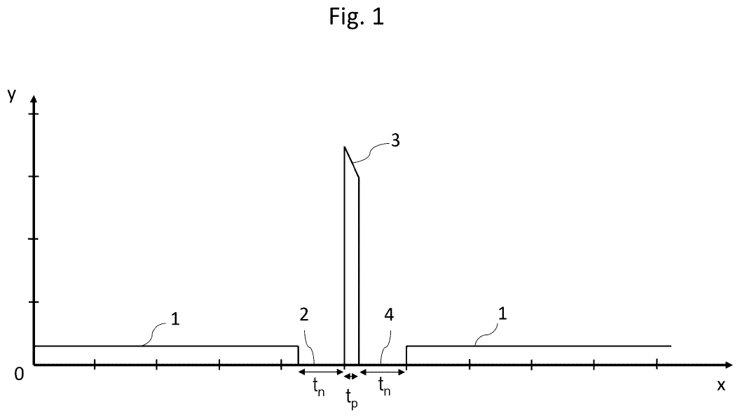

FIG. 1 shows a schematic diagram of the light intensity (Y-axis) of the light from the illumination unit over time (X-axis).

As an example, it is assumed that the light source of the illumination unit is an LED. The LED is pulsed so that the light intensity of the light emitted by the LED is varied between light pulse intervals 3, light base illumination intervals 1 and light pause intervals 2. The light intensity of the light base illumination interval 1 can correspond to the average value of the light intensity from the start of a light pulse interval 3 to the start of the following light pulse interval 3. In order to keep the average perceived brightness constant, the light intensity is reduced to zero directly before the light pulse interval 3 and directly after the light pulse interval 3 for a duration tₙ of a light pause interval. The duration tₙ before and after the light pulse interval 3, in which the light intensity is reduced to zero, is the same. The duration tₙ of the light pause intervals 2, 4 depends on the light intensity of the light base illumination intervals 1, the duration tₚ of the light pulse interval 3 and the maximum light intensity of the light pulse interval 3. A duration tₙ of the light pause intervals 2, 4 of 5 ms before and after the light pulse interval 3 with a driver current for driving the LED of 8 A and a pulse time of tₚ=500 μs has proven to be suitable, whereby the driver current for driving the LED in the light base illumination intervals 1 is 480 mA. In this example, a drop in light intensity of 10 to 20% can be seen in light pulse interval 3, which corresponds to a temperature increase of approx. 80 K in the LED chip.

The application of such LED lighting is designed for cameras with a frame rate of approx. 30 fps. Another option is to activate individual pulses or individual flashes of LED lighting with a trigger. The pulse frequency or the individual pulse of the LED lighting must be synchronized with the electronic shutter of the camera. In this case, a low pulse frequency of 30 Hz is possible. Normally, a flicker of light would be perceptible at a pulse frequency of 30 Hz. However, no light flickering is perceived by the method according to this disclosure.

A large number of LEDs can be installed in an LED illumination unit, for example 100 to 200 LEDs can be installed in an LED illumination unit.

Examples of applications for LED lighting for cameras with imaging sensors include traffic monitoring systems that are positioned at the edge of the road or on bridges to monitor vehicles in moving traffic, as well as code readers, for example in logistics.

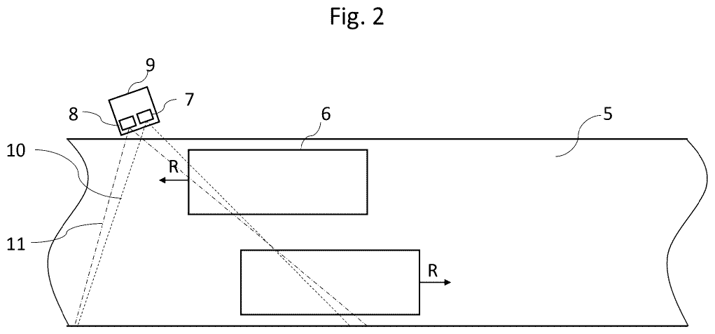

FIG. 2 shows vehicles 6 traveling on a roadway 5 along the directional arrow R. A traffic monitoring device 9 with a camera 7 and an illumination unit 8 is located on the side of the roadway 5, whereby the traffic monitoring device 9 monitors the vehicles in a monitoring area 10 of a camera 7 and a monitoring area 11 of the illumination unit 8. If, for example, a maximum speed of a vehicle 6 is exceeded, the camera 7 is activated, while the illumination unit 8 triggers a flicker-free light pulse 3 as shown in FIG. 1. Directly before and after the light pulse 3 there is a light pause interval 2, 4 in which the light intensity is reduced to zero. While the camera 7 is not activated, the illumination unit 8 emits a light base illumination interval 1.

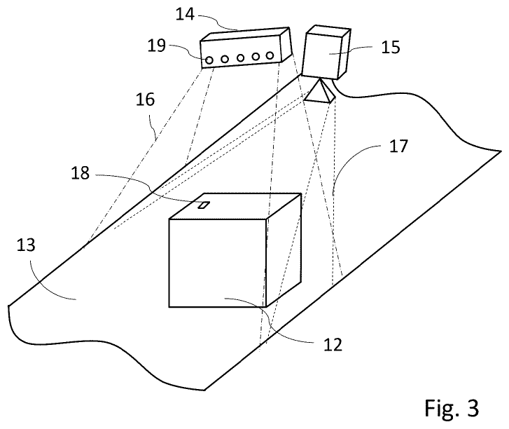

FIG. 3 shows a conveyor belt 13 on which objects such as packages 12 are transported. A code reader 15 records parcel codes 18 in a monitoring area 17 and decodes them. An illumination unit 14, which comprises several LEDs 19 schematically indicated here, emits flicker-free light within a monitoring area 16 as a light base illumination interval 1. A light pulse 3 is activated while the camera of the code reader captures an image of the parcel code 18. Directly before and after the light pulse 3 there is a light pause interval 2, 4 in which the light intensity is reduced to zero.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for illuminating a detection area of an imaging sensor by an illumination unit with at least one light source, the method comprising:
varying a light intensity of a light emitted by the at least one light source within a cycle between light pulse intervals, light base illumination intervals and light pause intervals,
where a frequency of successive light pulse intervals is less than 60 Hz,
wherein a light pause interval occurs before and immediately after a light pulse interval, respectively, and
wherein a light base illumination interval, a light intensity of which is less than that of the light pulse intervals, occurs between each of the light pause intervals that are located between two light pulse intervals,
wherein the light intensity of the light base illumination interval corresponds to an average light intensity of a cycle and/or the light intensity of a light pulse interval and the light pause intervals that are located immediately before and after the light pulse interval corresponds to the average light intensity of a cycle.

2. The method according to claim 1, wherein the light intensity decreases during a light pulse interval.

3. The method according to claim 2, wherein the light intensity decreases during the light pulse interval by a maximum of up to 10% or by a maximum of up to 20%.

4. The method according to claim 1, wherein the frequency of the successive light pulse intervals is less than 30 Hz.

5. The method according to claim 1, wherein a duration of a light pulse interval is less than 500 μs.

6. The method according to claim 1, wherein the light pause intervals immediately before and immediately after the light pulse interval are at least substantially equal in length.

7. The method according to claim 1, wherein a duration of a light pause interval is less than 5 ms.

8. The method according to claim 1, wherein the at least one light source is controlled by means of a driver control, the driver control generating a drive current signal to control the at least one light source.

9. The method according to claim 8, wherein the at least one light source is an LED or an LED string, which is controlled in the light pulse interval with a drive current with a current intensity of 8 A.

10. The method according to claim 8, wherein the at least one light source is an LED or an LED string which is controlled in the light base illumination interval with a driver current with a current intensity of between 150 mA and 450 mA.

11. The method according to claim 1, wherein the illumination unit comprises at least one first light source and at least one second light source, the at least one first light source being actuated to generate the light of the light pulse interval and the at least one second light source being actuated to generate the light of the light base illumination interval.

12. An illumination unit for illuminating a detection area of an imaging sensor comprising:
at least one light source; and
a driver control for driving the at least one light source by a drive current signal, the driver control being configured to
vary the drive current signal between light pulse intervals, light base illumination intervals and light pause intervals, a frequency of successive light pulse intervals being less than 60 Hz, and
such that the drive current signal has a light pause interval immediately before and immediately after a light pulse interval, respectively, and that a light base illumination interval, in which a current intensity of the driver current signal is lower than the current intensity of the driver current signal in the light pulse intervals, is provided between the light pause intervals that are located between two light pulse intervals,
wherein the driver control controls the drive current signal in such a way that the light intensity of the light base illumination interval corresponds to an average value of the light intensity of a cycle and/or the light intensity of a light pulse interval and the light pause intervals immediately before and after the light pulse interval corresponds to a mean value of the light intensity of a cycle.

13. The illumination unit according to claim 12, wherein the at least one light source is an LED.
